(19) United States
(12) Patent Application Publication
(10) Pub. No.: US 2006/0070272 A1
(43) Pub. Date: Apr. 6, 2006

(54) Point of sale single bottle sign holder

(75) Inventor: Joseph Visola, Modesto, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: E. & J. GALLO WINERY, Modesto, CA (US)

(21) Appl. No.: 10/950,831

(22) Filed: Sep. 27, 2004

(51) Int. Cl. G09F 3/00

(52) U.S. Cl. 40/310

(57) ABSTRACT

An advertising display device for mounting on a bottle having a top, a cylindrical neck and shoulders is disclosed. The device comprises a body for mounting an advertising display; and a plurality of nested tubes affixed to the body, the tubes having open bottom surfaces such that the bottom surfaces of the tubes having a central opening for permitting the passage there-through of the bottle top and neck; wherein the bottom surface of each tube is disposed lower than the tube which is nested immediately within it. When the neck of the bottle fits within the inner-most tube its top either contacts a closed top surface of the inner-most tube or one of the tubes engages the shoulders of the bottle and the neck of the bottle is engaged against the inner surface of the inner-most tube. Alternatively, when the top of the bottle contacts the bottom surface of one of the tubes, the neck of the bottle is engaged against the inner surface of a larger tube so as to stably support the display device when an advertising display is mounted thereto.

### BACKGROUND OF THE INVENTION

The present invention relates to devices for displaying advertising on a bottle or other container. In particular, the invention relates to a device for displaying advertising on a beverage bottle such as a wine bottle in a merchandising environment, such as a wine and spirits store, in which many different types and brands of beverages are displayed.

The beverage industry utilizes a wide variety of means for advertising at the point-of-sale. Such means include free standing signage as well as advertising displays mounted on individual bottles. While free-standing signage can typically be made larger and more prominent than bottle labels and displays mounted to bottles, rapidly changing inventories mean that there are advantages to advertising which can be attached to individual bottles. Such advertising is advantageous because it can be made more specific to the brand or type of beverage being sold. Moreover, traditional free-standing advertising displays rely upon rods, poles or other means to support the advertising media and thus are large and more difficult to move throughout a retail environment as inventories change. In addition, such displays are bulky and cumbersome to store when not in use.

Various types of point-of-sale advertising devices for attachment to bottles are known to the beverage industry. While beverage bottles have always displayed advertising in the form of labels, there has been a desire to further distinguish one brand or type of beverage from another by means of additional point-of-sale advertising that may not be permanently attached to a bottle. One type of bottle advertising display device utilizes flexible tags or labels that are mounted around the neck of a bottle and have advertising material hanging therefrom devices such as those of Jones et al., U.S. Pat. No. 4,208,819; Hoffman, U.S. Pat. No. 4,598,489; Grody, U.S. Pat. No. 5,390,435 and Markson, U.S. Pat. No. 5,960,973. Another type of advertising display is mounted on the neck and shoulders of a bottle and comprises a rigid structure upon which an advertising display may be printed such as those of Wasser, U.S. Pat. No. 1,999,011; Follett et al., U.S. Pat. No. 5,289,650; Maroszek et al., U.S. Pat. No. 5,348,156; and Klabunde, U.S. Pat. No. 6,321,473. Both of these types of displays share a disadvantage of traditional labels which is that they do not stand out vertically above the top of a bottle when it is displayed on its bottom, either alone or among other members of a case of beverage bottles.

Other types of advertising displays function to display advertising above the top of the bottle, in order to stand out among other merchandise. Boykin, U.S. Pat. No. 4,271,616 discloses a container sign holder comprising a flexible clasping ring which is fitted around the neck of a bottle having a spring hinge and a display support plate on which advertising can be mounted. Tsonas, U.S. Pat. No. 6,385,874 discloses a decorative card fitting over the neck of a bottle having a lower portion below the neck of the bottle and an upper portion extending above the top of the bottle upon which advertising can be displayed.

Despite the various types of bottle-mounted advertising displays known to the art, there remains a desire for methods of mounting more prominent advertising directly on bottles of the beverages to be sold.

### SUMMARY OF THE INVENTION

The present invention relates to an advertising display device which is adapted to be readily directly mountable on beverage bottles of various neck sizes. Specifically, the invention provides an advertising display device for mounting on a bottle having a top and a cylindrical neck comprising a body for mounting an advertising display, and a plurality of nested tubes affixed to the body. The tubes have open bottom surfaces each bottom surface having a central opening for permitting the passage there-through of the bottle top and neck. The bottom surface of each tube is disposed lower than the tube which is nested immediately within it wherein when either the top of the bottle contacts the closed top surface of the inner-most tube or one of the tubes engages the shoulders of the bottle, the neck of the bottle is engaged against the inner surface of the inner-most tube, and when the top of the bottle contacts the bottom surface of one of the tubes the neck of the bottle is engaged against the inner surface of the next larger tube so as to stably support the display device when an advertising display is mounted thereto. Thus, depending upon the diameter of the bottle neck, the neck will be engaged within one of the tubes so as to support the display device and any display mounted thereon. Progressively larger bottle necks will be engaged within successively larger tubes.

The device of the invention may be readily moved from one bottle and location to another by simple placement upon the neck of an upright bottle. By mounting directly on a bottle, there is no need to supply rods, poles or other means for supporting the advertising media. Moreover, a single device bearing generic advertising, such as for a particular brand or vineyard, is readily mountable on bottles having different neck sizes for such a brand. Further, the devices are readily transported and easily stored when not in use. When used to mount a rigid planar advertising display panel the a plurality of advertising display panels may be shipped or stored flat while the devices may be readily shipped and stored.

The body for mounting an advertising display can comprise clips, flat plate surfaces or other means to mount advertising displays as would be known to those of skill in the art. According to one aspect of the invention the body can comprise a planar panel to which advertising material may be attached by means such as adhesive, clips or the like. According to one preferred aspect of the invention, the body comprises a slot into which a rigid planar display panel may be inserted. According to this embodiment, the advertising display device may be readily moved from one brand or type of beverage to another while the advertising copy is exchanged by simple removal and substitution of a different display panel.

While the interiors of the nested tubes of the device may be any shape which will securely engage the necks of beverage bottles including polygonal shapes such as hexagons and octagons the tubes are preferably cylindrical. In addition, while the tubes need only be nested one within another, it is preferred that they be configured in a concentric manner such that they share the same center of gravity so as to provide greater stability.

### BRIEF DESCRIPTION OF THE FIGURES

FIG. 1 is a front elevation view of the advertising display device of the invention attached to a bottle and having an advertising piece attached thereto;

FIG. 2 is a front elevation view of the advertising display device depicted in FIG. 1;

FIG. 3 is a bottom plan view of the advertising display device depicted in FIG. 1;

FIG. 4 is a top plan view of the advertising display device depicted in FIG. 1;

FIGS. 5a and 5b are side cross-sectional views of the advertising display device depicted in FIG. 1 with and without a bottle;

FIG. 6 is a perspective view of an alternative advertising display device.

FIG. 7 is a side elevation view of the advertising display device depicted in FIG. 7;

FIG. 8 is a top plan view of the advertising display device depicted in FIG. 7; and

FIG. 9 is a bottom plan view of the advertising display device depicted in FIG. 7.

### DETAILED DESCRIPTION OF THE INVENTION

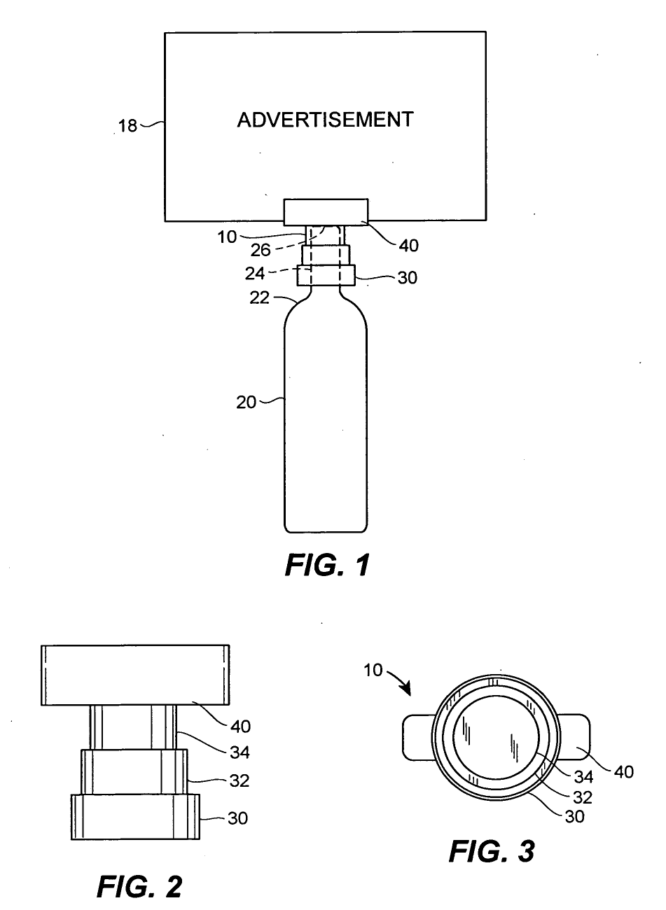

FIG. 1 depicts the advertising display device 10 of the invention mounted on a bottle 20 having shoulders 22, a neck 24 and a top 26. The device comprises a flat panel advertising piece 18 mounted thereon. As depicted in FIGS. 1 and 2, the display device 10 comprises a body 40 for mounting the advertising display piece 11 and a plurality of nested tubes 30, 32 and 34.

As further depicted in FIGS. 3, 5A and 5B the device comprises a plurality of nested tubes 30, 32 and 34 which are adapted to engage the necks of bottles of various diameters. In FIG. 5B, the bottle neck 24 is of a diameter too wide to be disposed within the innermost tube 34. Instead, the bottle neck 24 is engaged within the next widest tube 32 and the top 26 of the bottle contacts the bottom surface of the innermost tube 34. In this manner the device 10 is firmly stably engaged upon the bottle 20 and may function to support an advertising display (not shown) above the bottle 20. The device 10 may readily be removed from the bottle 20 when that bottle is sold or when sales inventory is restocked or moved. Alternatively, the device 10 may be readily removed from the bottle 20 and mounted on a different bottle of the same brand of beverage elsewhere in a retail display. The ability to readily move a display from one bottle to another and to move locations is a significant advantage over conventional signage which comprises permanent or semi-permanent supports within a store. Similarly, the device 10 may be removed from a beverage of one brand or style, have a different advertising display mounted on the body 40, and may then be mounted on a different brand or style of beverage elsewhere in a store.

The lengths of the tubes 30, 32 and 34 are all determined in a manner such that there is sufficient difference in the lengths between the tubes that the device will stably engage a bottle so as to support advertising media mounted above the device. The tubes are selected to have inner diameters capable of engaging bottle necks of various sizes. Such sizes could be 1¼, 1½, and 1⅝ inches although the tubes could be designed to fit with other standard and non-standard bottle neck and top sizes. It is preferred that the device comprise three tubes but as few as two and four or more may also be used as appropriate. Those of ordinary skill in the art can determine the lengths of the tubes so as to appropriately support advertising displays mounted on the device.

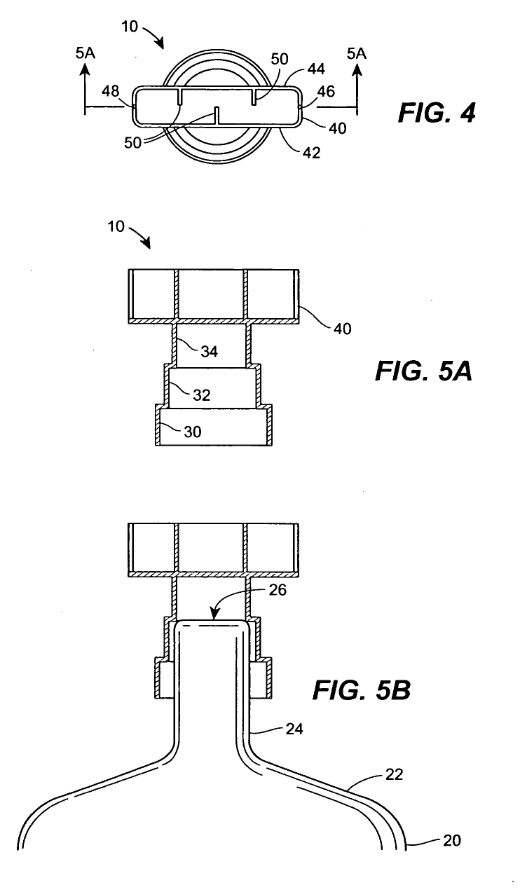

FIG. 4 depicts one aspect of the invention wherein the body 40 for mounting an advertising display comprises a pair of opposing rigid surfaces 42 and 44 such as can be fashioned from metal or plastic which define slots 46 and 48 between them. The slots 46 and 48 are sized such that a rigid planar display panel 18 such as can be produced from card-stock or plastic can be fitted there-between. To better support an advertising display panel 18 on the mounting body 40, rigid baffles 50 may also be disposed between the opposing rigid surfaces 42 and 44 to grip and support the display panel 18. Of course, numerous variations upon these means for mounting an advertising display on the body of the device would be apparent to those of ordinary skill in the art.

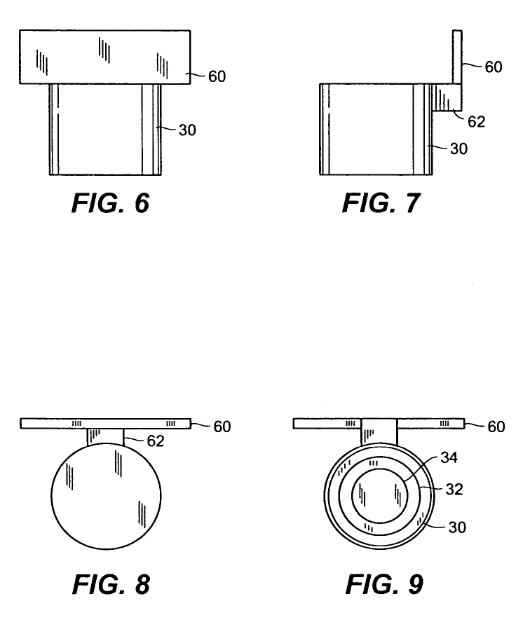

FIGS. 6-9 depict one alternative device according to the invention which comprises a plurality of nested tubes in the same arrangement as those of the device of FIG. 1 but comprises a different arrangement of a body for mounting an advertising display. Panel 60 is disposed laterally from the multiple tubes 30 (and others not shown) by a pair of supports 62 and can have advertising displays (not shown) adhered thereto by permanent or temporary adhesive or by use of clips or other attachment means. While panel 60 is depicted as being of modest dimensions, those of skill in the art would recognize that it can be made higher and/or wider depending on the needs for supporting particular advertising materials. In addition, it will be noted that the outer tube 30 extends axially to the top of the device and surrounds inner tubes 32 and 34. This arrangement functions to engage the neck 24 of a bottle in the same manner as the device of FIGS. 2 and 3 but maybe preferred for reasons of aesthetics or ease of manufacture.

Numerous modifications and variations in the practice of the invention are expected to occur to those skilled in the art upon consideration of the presently preferred embodiments thereof. Consequently, the only limitations which should be placed upon the scope of the invention are those which appear in the appended claims.

1-8. (canceled)

9. A method of advertising comprising displaying an advertisement on a device comprising a body for mounting an advertising display: and
a plurality of tubes each tube having a different width, affixed to said body, said tubes having open bottom surfaces and including a smallest tube, a largest tube and at least one tube of intermediate size between said smallest and largest tubes;
the bottom surfaces of said tubes having a central opening for permitting the passage there-through of the bottle top and neck; wherein the bottom surface of each tube is disposed lower than that of the next smaller tube and wherein when either the top of the bottle contacts a closed top surface of the smallest tube or one of the tubes engages the shoulders of the bottle, the neck of the bottle is engaged against the inner surface of the smallest tube, and when the top of the bottle contacts the bottom surface of one of the tubes the neck of the bottle is engaged against the inner surface of the next larger tube so as to stably support the display device when an advertising display is mounted thereto wherein the body for mounting an advertising display comprises a slot for insertion of a rigid planar display panel,
said device further comprising an advertising display which is a rigid planar panel mounted to the body thereof;
and mounting the device on a bottle having a top and a cylindrical neck.
